(19) United States
(12) Patent Application Publication
(10) Pub. No.: US 2022/0087361 A1
(43) Pub. Date: Mar. 24, 2022

(54) RUBBER FOAM FOR SHOE SOLE

(71) Applicant: MIZUNO CORPORATION, Osaka (JP)

(72) Inventors: Mitsuru Sato, Osaka (JP); Akira MORITA, Osaka (JP); Naoya HIGUCHI, Osaka (JP)

(21) Appl. No.: 17/337,702

(22) Filed: Jun. 3, 2021

(30) Foreign Application Priority Data
Jun. 5, 2020 (JP) 2020-098853

(51) Int. Cl. A43B 13/04; C08J 9/00; C08K 5/00; A43B 13/18; C08J 9/06

(52) U.S. Cl. CPC A43B 13/04; C08J 9/0061; C08K 5/0016; C08J 2309/06; C08J 9/06; C08J 2207/00; C08J 2307/00; A43B 13/187

(57) ABSTRACT

A rubber foam for a shoe sole is composed of a rubber composition for foaming containing a rubber composition and a foaming agent, the rubber foam having (i) a loss factor tan δ (24° C.) at a frequency of 10 Hz and 24° C. that is 0.07 or less and (ii) an absolute value of a slope of a change in loss factor tan δ with temperature between a loss factor tan δ (−15° C.) at the frequency of 10 Hz and −15° C. and the loss factor tan δ (24° C.) at the frequency of 10 Hz and 24° C., as calculated by the following equation, that is 0.002 or less:

the absolute value of the slope of the change in tan δ with temperature=|[tan δ (−15° C.)−tan δ (24° C.)]/39|.

### CROSS-REFERENCE TO RELATED APPLICATION

This application claims priority to Japanese Patent Application No. 2020-98853 filed on Jun. 5, 2020, the entire disclosure of which is incorporated by reference herein.

### BACKGROUND

The present invention relates to rubber foams that are used for shoe soles.

In shoes such as sports shoes, a foam is attached to an intermediate part (midsole or insole) of the shoe in order to reduce fatigue with improved walking comfort and wearing comfort and to prevent injuries etc.

For example, foam rubber for midsoles produced by foaming rubber has been proposed as such a foam. It is described that a shoe sole using the foam rubber provides wearing comfort similar to that provided by a shoe sole made of polyurethane etc. (see, e.g., Japanese Unexamined Patent Publication No. 2005-218799).

An ethylene vinyl acetate (EVA) foam has also been proposed as a foam for midsoles in view of durability, cost, etc. (see, e.g., Japanese Unexamined Patent Publication No. 2016-198496).

A foam containing a rubber component and a resin component and having a loss factor tan δ of 0.16 or less at a frequency of 10 Hz and 30° C. to 80° C. has also been proposed. It is described that the use of this foam reduces heat shrinkage of a foam sole (see, e.g., International Patent Publication No. WO 2013/108378).

### SUMMARY

Sports shoes etc. may be used not only at ordinary temperatures but also at low temperatures. However, it is difficult for the above conventional foams for shoe soles to maintain high resilience at low temperatures.

The present invention was made in view of the above problem, and it is an object of the present invention to provide a rubber foam for a shoe sole that has high resilience at ordinary temperatures and that can maintain high resilience even at low temperatures.

In order to achieve the above object, a rubber foam for a shoe sole according to the present invention is a rubber foam for a shoe sole that is composed of a rubber composition for foaming containing a rubber composition and a foaming agent. In the rubber foam, a loss factor tan δ (24° C.) at a frequency of 10 Hz and 24° C. is 0.07 or less and an absolute value of a slope of a change in loss factor tan δ with temperature between a loss factor tan δ (−15° C.) at the frequency of 10 Hz and −15° C. and the loss factor tan δ (24° C.) at the frequency of 10 Hz and 24° C., as calculated by the following equation (1), is 0.002 or less:

[Math 1]

the absolute value of the slope of the change in tan δ with temperature=|[tan δ (−15° C.)−tan δ (24° C.)]/39| (1).

According to the present invention, a rubber foam for a shoe sole can be provided which has high resilience at ordinary temperatures and which can maintain high resilience even at low temperatures.

### DETAILED DESCRIPTION

A suitable embodiment of the present invention will be described.

A rubber foam for a shoe sole according to the present invention is a crosslinked foam that is composed of a rubber composition for foaming containing a rubber composition and a foaming agent and that is produced by crosslinking and foaming the rubber composition.

### Rubber Composition

The rubber composition of the present invention is composed of either or both of natural rubber and synthetic rubber. Isoprene rubber, butadiene rubber, and styrene-butadiene rubber are used as synthetic rubber. These rubbers may be used singly or in combination of two or more. Natural rubber and synthetic rubber may be used in combination.

These rubbers have a double bond in their backbone and therefore have a free volume. Accordingly, the molecular chains of these rubbers are less likely to crystallize, and the molecular structures of these rubbers are less likely to be destroyed even under load. As a result, a rubber foam for a shoe sole that has high resilience at ordinary temperatures and that can maintain high resilience even at low temperatures can be obtained by using the rubber composition of the present invention.

As used herein, the “ordinary temperatures” refer to temperatures in the range of 24° C.±1° C. (23 to 25° C.), and the “low temperatures” refer to −15° C.±1° C. (−14 to −16° C.).

Either or both of natural rubber and isoprene rubber may be used out of the above rubbers. As natural rubber has a wider molecular weight distribution than other polymers, the processability in a kneading process etc. is improved. As the molecular chains of natural rubber and isoprene rubber are cut during kneading, natural rubber and isoprene rubber soften due to their reduced molecular weights, and the processability in the kneading process etc. is therefore improved. As a result, the processability of the rubber foam for a shoe sole is improved.

As butadiene rubber has a lower glass transition temperature (Tg) than other polymers, the use of butadiene rubber improves the cold resistance of the rubber foam for a shoe sole.

Styrene-butadiene rubber has a smaller number of straight chains due to copolymerization of styrene with butadiene. Accordingly, the use of styrene-butadiene rubber improves the processability of the rubber foam for a shoe sole and reduces cost.

The content of the rubber composition in the whole rubber foam for a shoe sole is suitably 40 mass% to 90 mass %. When the content of the rubber composition is lower than 40 mass %, it may be difficult to maintain rebound resilience. When the content of the rubber composition is higher than 90 mass %, processing may become difficult. For example, cracking may occur during forming into a shoe sole.

In the case where butadiene rubber is used, the total content of butadiene rubber in the whole rubber composition (i.e., based on the total mass of the rubber composition) is suitably 40 mass % to 100 mass %, more suitably 60 mass % to 100 mass %. Butadiene rubber has a lower glass transition temperature than other polymers. Accordingly, the use of the rubber composition containing butadiene rubber reduces the amount of change in loss factor tan δ at a frequency of 10 Hz which occurs when the temperature changes from an ordinary temperature to a low temperature. Especially with the content of butadiene rubber being within the above range, this amount of change in loss factor tan δ is particularly reduced, and the resilience at low temperatures is particularly improved.

A method for manufacturing natural rubber and various synthetic rubbers described above is not particularly limited, and commercially available rubbers can be used.

### Foaming Agent

The foaming agent is not particularly limited as long as it produces gas necessary to foam the rubber composition when heated. Specific examples of the foaming agent include N,N′-dinitrosopentamethylenetetramine, 4,4′-oxybis(benzenesulfonylhydrazide), azodicarbonamide, sodium hydrogen carbonate, sodium bicarbonate, ammonium bicarbonate, sodium carbonate, ammonium carbonate, azodicarbonamide (ADCA), dinitrosopentamethylenetetramine (DNPT), azobisisobutyronitrile, barium azodicarboxylate, and p,p′-oxybisbenzenesulfonylhydrazine (OBSH). These foaming agents may be used singly or in combination of two or more.

The content of the foaming agent in the rubber foam for a shoe sole is suitably 0.5 mass % to 10 mass %, more suitably 2 mass % to 5 mass %, based on the whole rubber composition. When the content of the foaming agent is lower than 0.5 mass %, it may not be possible to stably foam the rubber composition. When the content of the foaming agent is higher than 10 mass %, the foam cell diameter at the surface of the rubber foam or inside the rubber foam may vary due to overfoaming.

### Resin Composition

The rubber foam for a shoe sole according to the present invention may contain a resin composition as the resin composition tends to soften at high temperatures and the use of the resin composition can reduce the amount of foaming agent.

Examples of the resin composition include thermoplastic elastomers such as polybutadiene thermoplastic elastomers, polystyrene thermoplastic elastomers, olefin thermoplastic elastomers, polyester thermoplastic elastomers, urethane thermoplastic elastomers, amide thermoplastic elastomers, and polyvinyl chloride thermoplastic elastomers. These resin compositions can be used singly or in combination of two or more.

The resin composition more easily softens at high temperatures than a rubber component. Accordingly, the use of the resin composition allows uniform foaming of the entire rubber composition. The resin composition has a higher glass transition temperature than the rubber component, and the loss factor tan δ changes by a large amount when the temperature changes from an ordinary temperature to a low temperature. Accordingly, when the content of the resin composition is too high, the rubber foam for a shoe sole has reduced resilience at low temperatures. The content of the resin composition in the rubber foam for a shoe sole is therefore suitably 40 mass % or less based on the whole rubber composition (i.e., the sum of the mass of the rubber composition and the mass of the resin composition). The content of the resin composition in the rubber foam for a shoe sole is suitably 15 mass % or more based on the whole rubber composition. In this case, the rubber composition can be foamed particularly uniformly.

### Plasticizer

The rubber foam for a shoe sole according to the present invention may contain a plasticizer. Examples of the plasticizer include: mineral oils such as paraffinic, naphthenic, and aromatic mineral oils; vegetable oils such as pine tar; ester compounds such as fatty acid esters, phthalates, and phosphate esters; and chemical synthetic oils such as polyalphaolefins.

The plasticizer suitably has a kinematic viscosity v40 of 19 cst or less at 40° C. With the kinematic viscosity v40 of the plasticizer being 19 cst or less, the loss factor tan δ at a frequency of 10 Hz and low temperatures can be more easily reduced, and the rubber foam for a shoe sole can maintain higher resilience at low temperatures.

The content of the plasticizer is suitably 20 mass % or more, more suitably 30 mass % or more, based on the whole rubber composition (the total of the rubber composition and the resin composition in the case where the rubber foam for a shoe sole contains the resin composition). With the content of the plasticizer being 20 mass % or more, the loss factor tan δ at a frequency of 10 Hz can be more easily reduced.

The content of the plasticizer is suitably 40 mass % or less based on the whole rubber composition (the total of the rubber composition and the resin composition in the case where the rubber foam for a shoe sole contains the resin composition). When the content of the plasticizer is higher than 40 mass %, the rate of decrease in loss factor tan δ at a frequency of 10 Hz decreases with respect to the rate of increase in amount of the plasticizer added, and it may therefore be difficult to efficiently reduce the loss factor tan δ.

The rubber foam for a shoe sole according to the present invention can be obtained by adding a crosslinking agent, a crosslinking aid, a foaming aid, a vulcanization accelerator, a processing aid, a reinforcing agent, a silane coupling agent, etc. to the above rubber composition for foaming, and crosslinking and foaming the resultant rubber composition under predetermined conditions.

### Crosslinking Agent

The crosslinking agent need not be particularly limited, and sulfur that is commonly used as a crosslinking agent for rubber and an organic peroxide that promotes peroxide crosslinking can be used as the crosslinking agent. Examples of the organic peroxide include dicumyl peroxide, di-t-butyl peroxide, 2,5-dimethyl-2,5-di-(t-butylperoxy)hexane, 2,5-dimethyl-2,5 -di-(t-butylperoxy)hexin-3,1,3-bis(t-butylperoxyisopropyl)benzene, 1,1-bis(t-butylperoxy)-3,3,5-trimethylcyclohexane, n-butyl-4,4-bis(t-butylperoxy)valerate, benzoyl peroxide, p-chlorobenzoyl peroxide, 2,4-dichlorobenzoyl peroxide, t-butylperoxybenzoate, t-butylperbenzoate, t-butylperoxyisopropyl carbonate, diacetyl peroxide, lauroyl peroxide, and t-butylcumyl peroxide. These crosslinking agents can be used singly or in combination of two or more.

The content of the crosslinking agent in the rubber foam for a shoe sole is suitably 1 to 7 mass %, more suitably 2 to 5 mass %, based on the whole rubber composition. When the content of the crosslinking agent is lower than 1 mass %, the rebound resilience may be reduced due to insufficient crosslinking. When the content of the crosslinking agent is higher than 7 mass %, crosslinking may proceed excessively, which results in insufficient foaming.

### Crosslinking Aid

The crosslinking aid need not be particularly limited, and examples of the crosslinking aid include zinc oxide, divinylbenzene, trimethylolpropane trimethacrylate, 1,6-hexanediol methacrylate, 1,9-nonanediol dimethacrylate, 1,10-decanediol methacrylate, trimellitic acid triallyl ester, triallyl isocyanurate, neopentyl glycol dimethacrylate, 1,2,4-benzenetricarboxylic acid triallyl ester, tricyclodecane dimethacrylate, and polyethylene glycol diacrylate. These crosslinking aids may be used singly or in combination of two or more.

The content of the crosslinking aid in the rubber foam for a shoe sole is suitably 1 to 10 mass %, more suitably 3 to 5 mass %, based on the whole rubber composition. When the content of the crosslinking aid is lower than 1 mass %, crosslinking may not proceed sufficiently, which results in reduced rebound resilience. When the content of the crosslinking aid is higher than 10 mass %, it may be difficult to reduce the product weight due to an increased specific gravity of the rubber composition.

### Foaming Aid

The foaming aid need not be particularly limited, and examples of the foaming aid include urea compounds and zinc compounds. These foaming aids can be used singly or in combination of two or more.

The content of the foaming aid in the rubber foam for a shoe sole is suitably 0.5 to 10 mass % based on the whole rubber composition. It is a standard to add equal amounts of foaming agent and foaming aid. Some foaming agents generate formaldehyde etc. when the amount of foaming aid is smaller than that of foaming agent. Accordingly, it is necessary to adjust the amount of forming aid as appropriate according to the amount of foaming agent.

### Vulcanization Accelerator

The vulcanization accelerator need not be particularly limited, and examples of the vulcanization accelerator include sulfenamide vulcanization accelerators, guanidine vulcanization accelerators, thiazole vulcanization accelerators, thiuram vulcanization accelerators, thiourea vulcanization accelerators, dithiocarbamate vulcanization accelerators, aldehyde-amine or aldehyde-ammonia vulcanization accelerators, imidazoline vulcanization accelerators, and xanthate vulcanization accelerators. These vulcanization accelerators can be used singly or in combination of two or more.

The content of the vulcanization accelerator in the rubber foam for a shole sole is suitably 0.2 to 3 mass % based on the whole rubber composition. When the content of the vulcanization accelerator is lower than 0.2 mass %, productivity may be reduced due to increased time for forming into a shoe sole, and the rebound resilience may be reduced due to insufficient crosslinking. When the content of the vulcanization accelerator is higher than 3 mass %, blooming is more likely to occur in a formed product.

### Processing Aid

In order to improve fluidity and slipperiness of the rubber composition for foaming, to reduce adhesion of the rubber composition to a kneading machine such as rolls, and to improve a mold release effect, the rubber foam for a shoe sole according to the present invention may contain a processing aid.

Examples of the processing aid include higher fatty acid esters, stearic acid, metal soaps, and polyethylene waxes.

The content of the processing aid in the rubber foam for a shoe sole is suitably 0 to 2 mass % based on the whole rubber composition. When the content of the processing aid is higher than 2 mass %, the material may slip on the roll due to excessively high lubricity, which makes it difficult to mix the material during roller processing.

### Reinforcing Agent

In order to improve mechanical properties such as tensile strength and wear resistance of vulcanized rubber, the rubber foam for a shoe sole according to the present invention may contain a reinforcing agent.

Examples of the reinforcing agent include silica, carbon black, magnesium carbonate, calcium carbonate, clay, talc, and barium sulfate.

The content of the reinforcing agent in the rubber foam for a shoe sole is suitably 5 to 50 mass % based on the whole rubber composition. When the content of the reinforcing agent is lower than 5 mass %, the rubber foam may not have sufficient strength. When the content of the reinforcing agent is higher than 50 mass %, the rebound resilience may decrease and the specific gravity of the rubber foam may become too high.

The rubber foam for a shoe sole according to the present invention is characterized in that the loss factor tan δ (24° C.) at a frequency of 10 Hz and 24° C. is 0.07 or less in order to increase the modulus of repulsion elasticity and to obtain high resilience.

This loss factor tan δ is a value defined by loss factor tan δ=loss modulus E″/storage modulus E′. The frequency of 10 Hz usually represents the natural frequency (7 to 12 Hz) of a member for a shoe sole when a human walks or runs. Accordingly, when the rubber foam for a shoe sole whose loss factor tan δ (24° C.) at a frequency of 10 Hz and 24° C. is 0.07 or less is used for, e.g., the midsole of a shoe, the modulus of repulsion elasticity is increased and high resilience is provided.

The rubber foam for a shoe sole according to the present invention is characterized in that the absolute value of a slope of a change in loss factor tan δ with temperature between a loss factor tan δ (−15° C.) at a frequency of 10 Hz and −15° C. and the above loss factor tan δ (24° C.), as calculated by the following equation (2), is 0.002 or less:

[Math 2]

the absolute value of the slope of the change in tan δ with temperature=|[tan δ (−15° C.)−tan δ (24° C.)]/value of a temperature change|=|[tan δ (−15° C.)−tan δ (24° C.)]/39| (2).

With the absolute value of the slope of the change in tan δ with temperature being 0.002 or less, the influence of the change in tan δ with temperature is small, and therefore a change in modulus of repulsion elasticity at low temperatures is small.

That is, in the rubber foam for a shoe sole according to the present invention, the loss factor tan δ (24° C.) is 0.07 or less, and the absolute value of the slope of the change in tan δ with temperature is 0.002 or less. The rubber foam for a shoe sole therefore has high resilience at ordinary temperatures and can maintain high resilience even at low temperatures.

In order to improve the modulus of repulsion elasticity and to reliably improve resilience at low temperatures, the loss factor tan δ (−15° C.) is suitably 0.12 or less.

The loss factor tan δ of the rubber foam for a shoe sole can be determined by analyzing data measured by dynamic viscoelasticity measurement of the rubber foam using data processing software.

Specifically, the value of tan δ at 10 Hz and 24° C. (or −15° C.) of the rubber foam for a shoe sole is extracted using the data processing software, based on data obtained for predetermined measurement temperatures and predetermined measurement frequencies. For example, “Rheogel-E4000F” made by UBM can be used for the dynamic viscoelasticity measurement, and the data processing software is “UBM Rheo Station ver 7.0” made by UBM.

In the rubber foam for a shoe sole, the absolute value of the difference between the storage modulus E′ (24° C.) (MPa) at a frequency of 10 Hz and 24° C. and the storage modulus E′ (−15° C.) (MPa) at a frequency of 10 Hz and −15° C. is suitably 0.30 MPa or less. This configuration reduces a change in hardness at low temperatures.

As used herein, the “storage modulus” refers to a storage modulus as measured by a method in examples that will be described later.

Similarly, in order to reduce a change in hardness at low temperatures, the absolute value of the difference in C hardness (24° C.) at 24° C. and C hardness (−15° C.) at −15° C. is suitably 5.0 or less.

As used herein, the “C hardness” refers to C hardness as measured by a method in the examples that will be described later.

As the rubber foam is used for a shoe, the specific gravity of the rubber foam for a shoe sole according to the present invention is suitably 0.6 or less, and is suitably 0.4 or less particularly when the rubber foam is used for the midsole of a shoe.

Next, a method for manufacturing the rubber foam for a shoe sole according to the present invention will be described. The method for manufacturing the rubber foam for a shoe sole according to the present invention includes a kneading process of producing a rubber composition for foaming and a foaming and forming process of foaming the rubber composition for foaming and forming the foamed rubber composition into a desired shape.

### Kneading Process

First, raw materials such as a rubber composition as a base material, a crosslinking agent, and a foaming agent are placed into a kneading machine, and these raw materials are kneaded by the kneading machine. A rubber composition for foaming is thus produced.

Examples of the kneading machine include mixing rolls, calendar rolls, a Banbury mixer, and a kneader.

For example, a rubber composition, a resin composition, a plasticizer, a crosslinking aid, a reinforcing agent, a crosslinking agent, a vulcanization accelerator, a foaming aid, and a foaming agent are placed in this order onto rolls set to a predetermined temperature (e.g., a surface temperature of 40 to 60° C.) and kneaded by the rolls. Thereafter, preforming such as sheeting or pelletizing is performed.

The kneading process may be performed in stages using a plurality of kneading machines. For example, a rubber composition, a resin composition, a plasticizer, a crosslinking aid, and a reinforcing agent are placed into a kneader and kneaded by the kneader. The kneaded composition is then transferred to rolls, and a crosslinking agent and a foaming agent are placed onto the rolls and kneaded by the rolls. Thereafter, preforming such as sheeting or pelletizing is performed.

### Foaming and Forming Process

Subsequently, a mold is filled with the rubber composition for foaming obtained by the kneading process. The mold is then heated to cause foaming by the foaming agent to proceed. Thereafter, a forming process and a mold release process are performed. The rubber composition for foaming with a desired shape is thus produced.

Although the heating temperature for the heating varies depending on the types of foaming agent and foaming aid, the heating is performed at a temperature (e.g., 120 to 180° C.) equal to or higher than the decomposition temperature of the foaming agent used. The heating may be performed with the mold being filled with the rubber composition for foaming in a pressed state, or may be performed under an ordinary pressure to cause decomposition of the foaming agent to proceed.

The rubber foam for a shoe sole according to the present invention is manufactured in this manner.

### EXAMPLES

The present invention will be described based on examples. The present invention is not limited to these examples, and these examples may be modified or changed based on the spirit and scope of the present invention, and such modifications and changes are not excluded from the scope of the present invention.

### Examples 1 to 20 and Comparative Examples 1 to 13

### Manufacturing of Rubber Foam for Shoe Sole

Rubber foams for a shoe sole of Examples 1 to 20 and Comparative Examples 1 to 11 having compositions shown in Tables 1 to 3 (numerical values in the tables represent parts by mass of each component) were manufactured by the following manufacturing method.

### Kneading Process

First, a rubber composition, a resin composition, a plasticizer, a crosslinking aid, and a reinforcing agent that are shown in Tables 1 to 3 were placed into a kneader set to 40° C., and these raw materials were kneaded for 20 minutes. Next, the resultant kneaded composition was placed onto 8-inch open rolls (temperature: 60° C.). Then, a crosslinking agent, a foaming aid, and a vulcanization accelerator that are shown in Tables 1 to 3 were added to this kneaded composition, and these raw materials were kneaded for 10 minutes. Subsequently, a foaming agent shown in Tables 1 to 3 was added to the resultant kneaded composition, and these raw materials were kneaded for 10 minutes. A rubber composition for foaming was thus produced.

### Foaming and Forming Process

First, a mold (length: 162 mm, width: 211 mm, height: 15 mm) was filled with 570 g of the produced rubber composition for foaming, and was press-formed at 120° C. and 15 MPa until the entire rubber composition for foaming was uniformly foamed. Next, the resultant rubber composition for foaming was removed from the mold, was placed in another mold (length: 265 mm, width: 345 mm, height: 22 mm), and was press-formed at 145° C. and 15 MPa for 15 minutes to foam the rubber composition for foaming. The rubber foams for a shoe sole of Examples 1 to 20 and Comparative Examples 1 to 11 were manufactured in this manner.

### Manufacturing of Resin Foam for Shoe Sole

Resin foams for a shoe sole of Comparative Examples 12 and 13 having compositions shown in Table 3 (numerical values in the tables represent parts by mass of each component) were manufactured by the following manufacturing method.

### Kneading Process

First, a resin composition, a crosslinking agent, a foaming agent, a crosslinking aid, a processing aid, a silane coupling agent, and a reinforcing agent that are shown in Table 3 were placed onto 8-inch open rolls (temperature: 100° C.), and these raw materials were then kneaded for 10 minutes. A resin composition for foaming was thus produced.

### Foaming and Forming Process

First, a mold (length: 145 mm, width: 175 mm, height: 10 mm) was filled with 245 g of the produced resin composition for foaming, and was press-formed at 165° C. and 15 MPa for 17 minutes.

Next, the resultant resin composition for foaming was removed from the mold and processed to a thickness of 15±1 mm.

Thereafter, this resin composition for foaming with the adjusted thickness was placed in another mold (length: 125 mm, width: 200 mm, height: 10 mm) and press-formed at 165° C. and 15 MPa. After the press forming, the mold was cooled for 20 minutes until the temperature of the mold reached an ordinary temperature. The formed foam was then removed from the mold. The resin foams for a shoe sole of Comparative Examples 12 to 13 were manufactured in this manner.

### Measurement of Specific Gravity

The specific gravities of the produced rubber foams for a shoe sole and resin foams for a shoe sole were measured according to JIS K 7311 (water displacement method). More specifically, foam samples (length: 20±1 mm, width: 15±1 mm, thickness: 10±1 mm) were prepared, and the specific gravity (g/cm³) of each foam sample was calculated by the following equation (3) at a measurement temperature of 20±3° C. using an electronic hydrometer (made by Alfa Mirage Co., Ltd., trade name: MDS-300). The results are shown in Tables 1 to 3.

[Math 3]

D (g/cm³)=W₁/(W₁−W₂) (³)

In the equation, D represents specific gravity, W₁ represents weight in air, and W₂ represents weight in water.

### Measurement of C Hardness

The hardnesses of the produced rubber foams for a shoe sole and resin foams for a shoe sole were measured according to JIS K 6253. More specifically, foam samples (length: 50±1 mm, width: 50±1 mm, thickness: 10±1 mm) were prepared, and the C hardness of each foam sample was measured using an Asker Durometer Type C made by KOBUNSHI KEIKI CO., LTD. More specifically, the Asker Durometer Type C was pressed against each foam sample with a load of 9.81 N at 24° C. and −15° C., and a maximum instantaneous value at each temperature was read from the scale. The absolute value of the difference between the C hardness at 24° C. and the C hardness at −15° C. was calculated using the obtained C hardnesses. The results are shown in Tables 1 to 3.

### Measurement of Modulus of Repulsion Elasticity

The moduli of repulsion elasticity of the produced rubber foams for a shoe sole and resin foams for a shoe sole were measured according to ASTM-D2632. More specifically, foam samples (thickness: 10±1 mm) were prepared, and the modulus of repulsion elasticity of each foam sample was measured using a Vertical Rebound Resilience Tester GT-7042-V made by GOTECH. A metal plunger was dropped eight times at five-second intervals at 24° C. and −15° C., and the height to which the metal plunger rebounded (rebound height) was read from the scale (%) for the last five times. The average of the read values was calculated as the modulus of repulsion elasticity (%). The rate of change (%) in modulus of repulsion elasticity was also calculated by the following equation (4). The results are shown in Tables 1 to 3.

[Math 4]

The rate of change in modulus of repulsion elasticity (%)=(1−((modulus of repulsion elasticity at −15° C.)/(modulus of repulsion elasticity at 24° C.))×100 (4)

### Measurement of Loss Factor tan δ

Dynamic viscoelasticity measurement was carried out for the produced rubber foams for a shoe sole and resin foams for a shoe sole. This measurement was carried out under measurement conditions that will be described below by using a dynamic viscoelasticity measuring device (Rheogel-E4000F, made by UBM). Specifically, test pieces were obtained by cutting the rubber foams for a shoe sole and resin foams for a shoe sole obtained in the examples and the comparative examples into strips with a length of 30 mm, a width of 6 mm, and a thickness of 2 mm. Next, with both ends of each test piece fixed to fixing portions of the dynamic viscoelasticity measuring device, a load was applied so as not to loosen the test piece and the test piece was held in tension. In this state, a shaker of the dynamic viscoelasticity measuring device was driven to apply dynamic stress to the test piece to cause dynamic strain. The dynamic stress and dynamic strain at this time were detected by detectors, and the phase difference and the dynamic complex modulus were obtained based on the waveforms of the dynamic stress and dynamic strain to determine the storage modulus E′ and the loss modulus E″. The measurement conditions for the dynamic viscoelasticity measurement using the dynamic viscoelasticity measuring device are as follows.

Measurement Conditions

Measurement mode: frequency and temperature dependence

Strain waveform: sine wave

Measurement frequency settings: 100 Hz, 50 Hz, 30 Hz, 10 Hz, 6 Hz, and 3 Hz

Strain control: 50 μm (automatic control)

Static load control: automatic static load

Measurement temperature: −20° C. to 50° C.

Step temperature: 2° C.

Rate of temperature increase: 2° C./min

Hold time: 0 sec

Offset temperature: −30° C.

Data of the storage modulus E′ (24° C.) at a frequency of 10 Hz and 24° C. and data of the storage modulus E′ (−15° C.) at a frequency of 10 Hz and −15° C. were extracted from data obtained by the measurement using the dynamic viscoelasticity measuring device, and the absolute value of the difference between the storage modulus E′ (24° C.) and the storage modulus E′ (−15° C.) was calculated.

Moreover, data of tan δ (24° C.) at 10 Hz and 24° C. and data of tan δ (−15° C.) at 10 Hz and −15° C. were extracted from the data obtained by the measurement using the dynamic viscoelasticity measuring device, and the absolute value of a slope of a change in tan δ with temperature was calculated using the above equation (2). The results are shown in Tables 1 to 3.

In the above measurement of the C hardness, rebound resilience, and loss factor tan δ, measurement was carried out three times at 24° C., and the result of the measurement in which the measurement temperature was closest to 24° C. among the three measurements was used as the measurement result for 24° C. Moreover, measurement was carried out three times at −15° C., and the result of the measurement in which the measurement temperature was closest to −15° C. among the three measurements was used as the measurement result for −15° C.

TABLE 1

| | | Examples | | | | | | | | |
|---|---|---|---|---|---|---|---|---|---|---|
| | | 1 | 2 | 3 | 4 | 5 | 6 | 7 | 8 | 9 |
| Mixing | Natural Rubber (*1) | 100.00 | | | | | | | | |
| Ratio | Synthetic Rubber A (*2) | | 100.00 | 100.00 | 100.00 | 100.00 | 85.00 | 80.00 | 70.00 | 60.00 |
| (Parts | Synthetic Rubber B (*3) | | | | | | | | | |
| by Mass) | Synthetic Rubber C (*4) | | | | | | | | | |
| | Resin A (*5) | | | | | | 15.00 | 20.00 | 30.00 | 40.00 |
| | Resin A (*6) | | | | | | | | | |
| | Resin B (*7) | | | | | | | | | |
| | Resin C (*8) | | | | | | | | | |
| | Reinforcing Agent (*9) | 15.00 | 15.00 | 15.00 | 15.00 | 15.00 | 15.00 | 15.00 | 15.00 | 15.00 |
| | Reinforcing Agent (*10) | | | | | | | | | |
| | Plasticizer (*11) | 20.00 | 20.00 | | | | | | | |
| | Plasticizer (*12) | | | 20.00 | 40.00 | | | | | |
| | Plasticizer (*13) | | | | | 20.00 | | | | |
| | Plasticizer (*14) | | | | | | | | | |
| | Plasticizer (*15) | | | | | | | | | |
| | Plasticizer (*16) | | | | | | | | | |
| | Plasticizer (*17) | | | | | | 40.00 | 40.00 | 40.00 | 40.00 |
| | Silane Coupling Agent (*18) | | | | | | | | | |
| | Processing Aid (*19) | | | | | | | | | |
| | Crosslinking Aid A (*20) | 5.00 | 5.00 | 5.00 | 5.00 | 5.00 | 5.00 | 5.00 | 5.00 | 5.00 |
| | Crosslinking Agent A (*21) | 3.00 | 3.00 | 3.00 | 3.00 | 3.00 | 3.00 | 3.00 | 3.00 | 3.00 |
| | Crosslinking Agent B (*22) | | | | | | | | | |
| | Vulcanization Accelerator | 0.50 | 0.50 | 0.50 | 0.50 | 0.50 | 0.50 | 0.50 | 0.50 | 0.50 |
| | A (*23) | | | | | | | | | |
| | Vulcanization Accelerator | 0.20 | 0.20 | 0.20 | 0.20 | 0.20 | 0.20 | 0.20 | 0.20 | 0.20 |
| | B (*24) | | | | | | | | | |
| | Crosslinking Aid B (*25) | | | | | | | | | |
| | Foaming Agent (*26) | 3.00 | 3.00 | 3.00 | 3.00 | 3.00 | 3.00 | 3.00 | 3.00 | 3.00 |
| | Foaming Agent (*27) | | | | | | | | | |
| | Foaming Aid (*28) | 3.00 | 3.00 | 3.00 | 3.00 | 3.00 | 3.00 | 3.00 | 3.00 | 3.00 |
| | Total | 149.70 | 149.70 | 149.70 | 169.70 | 149.70 | 169.70 | 169.70 | 169.70 | 169.70 |
| Evaluation | Specific Gravity (g/cm³) | 0.22 | 0.24 | 0.24 | 0.22 | 0.24 | 0.23 | 0.25 | 0.29 | 0.27 |
| | C Hardness (Skin Off, | 9 | 14 | 12 | 10 | 14 | 12 | 14 | 22 | 24 |
| | −15° C.) (−) | | | | | | | | | |
| | C Hardness (Skin Off, | 9 | 15 | 13 | 11 | 15 | 13 | 14 | 18 | 20 |
| | 24° C.) (−) | | | | | | | | | |
| | Modulus of Repulsion | 57 | 50 | 53 | 61 | 52 | 62 | 65 | 65 | 61 |
| | Elasticity (Skin Off, | | | | | | | | | |
| | −15° C.) (%) | | | | | | | | | |
| | Modulus of Repulsion | 78 | 77 | 77 | 77 | 77 | 74 | 76 | 78 | 76 |
| | Elasticity (Skin Off, | | | | | | | | | |
| | 24° C.) (%) | | | | | | | | | |
| | tan δ (10 Hz, −15° C.) (−) | 0.070 | 0.069 | 0.060 | 0.053 | 0.075 | 0.068 | 0.071 | 0.075 | 0.082 |
| | tan δ (10 Hz, 24° C.) (−) | 0.024 | 0.019 | 0.026 | 0.021 | 0.017 | 0.013 | 0.020 | 0.024 | 0.028 |
| | Storage Modulus E′ | 0.290 | 0.364 | 0.391 | 0.285 | 0.514 | 0.370 | 0.354 | 0.526 | 0.659 |
| | (−15° C.) (MPa) | | | | | | | | | |
| | Storage Modulus E′ | 0.290 | 0.340 | 0.346 | 0.286 | 0.356 | 0.348 | 0.312 | 0.437 | 0.504 |
| | (24° C.) (MPa) | | | | | | | | | |
| | Absolute Value of Slope of | 0.0012 | 0.0013 | 0.0009 | 0.0008 | 0.0015 | 0.0014 | 0.0013 | 0.0013 | 0.0014 |
| | Change in tan δ with | | | | | | | | | |
| | Temperature (−) | | | | | | | | | |
| | Rate of change in Modulus | 27 | 35 | 31 | 21 | 32 | 16 | 14 | 17 | 20 |
| | of Repulsion Elasticity (%) | | | | | | | | | |
| | Absolute Value of Difference | 0 | 1 | 1 | 1 | 1 | 1 | 0 | 4 | 4 |
| | in C Hardness (−) | | | | | | | | | |
| | Absolute Value of Difference | 0 | 0.024 | 0.045 | 0.001 | 0.158 | 0.022 | 0.042 | 0.089 | 0.155 |
| | in Storage Modulus E′ (MPa) | | | | | | | | | |

TABLE 2

| | | Examples | | | | | |
|---|---|---|---|---|---|---|---|
| | | 10 | 11 | 12 | 13 | 14 | 15 |
| Mixing | Natural Rubber (*1) | | | | | | |
| | Synthetic Rubber A (*2) | 60.00 | 50.00 | 40.00 | 30.00 | 20.00 | |
| | Synthetic Rubber B (*3) | 40.00 | 50.00 | 60.00 | 70.00 | 80.00 | 100.00 |
| | Synthetic Rubber C (*4) | | | | | | |
| | Resin A (*5) | | | | | | |
| | Resin A (*6) | | | | | | |
| | Resin B (*7) | | | | | | |
| | Resin C (*8) | | | | | | |
| | Reinforcing Agent (*9) | 12.00 | 12.00 | 12.00 | 12.00 | 12.00 | 12.00 |
| | Reinforcing Agent (*10) | | | | | | |
| | Plasticizer (*11) | 20.00 | 20.00 | 20.00 | 20.00 | 20.00 | 20.00 |
| | Plasticizer (*12) | | | | | | |
| | Plasticizer (*13) | | | | | | |
| | Plasticizer (*14) | | | | | | |
| | Plasticizer (*15) | | | | | | |
| | Plastiticzer (*16) | | | | | | |
| | Plasticizer (*17) | | | | | | |
| | Silane Coupling Agent (*18) | | | | | | |
| | Processing Aid (*19) | | | | | | |
| | Crosslinking Aid A (*20) | 5.00 | 5.00 | 5.00 | 5.00 | 5.00 | 5.00 |
| | Crosslinking Agent A (*21) | 3.00 | 3.00 | 3.00 | 3.00 | 3.00 | 3.00 |
| | Crosslinking Agent B (*22) | | | | | | |
| | Vulcanization Accelerator A (*23) | 0.50 | 0.50 | 0.50 | 0.50 | 0.50 | 0.50 |
| | Vulcanization Accelerator B (*24) | 0.20 | 0.20 | 0.20 | 0.20 | 0.20 | 0.20 |
| | Crosslinking Aid B (*25) | | | | | | |
| | Foaming Agent (*26) | 3.00 | 3.00 | 3.00 | 3.00 | 3.00 | 3.00 |
| | Foaming Agent (*27) | | | | | | |
| | Foaming Aid (*28) | 3.00 | 3.00 | 3.00 | 3.00 | 3.00 | 3.00 |
| | Total | 146.70 | 146.70 | 146.70 | 146.70 | 146.70 | 146.70 |
| Evaluation | Specific Gravity (g/cm³) | 0.33 | 0.31 | 0.29 | 0.30 | 0.33 | 0.32 |
| | C Hardness (Skin Off, −15° C.) (−) | 23 | 18 | 20 | 21 | 22 | 23 |
| | C Hardness (Skin Off, 24° C.) (−) | 25 | 21 | 20 | 22 | 24 | 25 |
| | Modulus of Repulsion Elasticity | 66 | 63 | 68 | 69 | 71 | 72 |
| | (Skin Off, −15° C.) (%) | | | | | | |
| | Modulus of Repulsion Elasticity | 80 | 81 | 80 | 79 | 80 | 80 |
| | (Skin Off, 24° C.) (%) | | | | | | |
| | tan δ (10 Hz, −15° C.) (−) | 0.057 | 0.053 | 0.051 | 0.050 | 0.047 | 0.042 |
| | tan δ (10 Hz, 24° C.) (−) | 0.018 | 0.021 | 0.023 | 0.025 | 0.026 | 0.028 |
| | Storage Modulus E′ (−15° C.) (MPa) | 0.285 | 0.316 | 0.287 | 0.303 | 0.271 | 0.342 |
| | Storage Modulus E′ (24° C.) (MPa) | 0.312 | 0.345 | 0.311 | 0.326 | 0.290 | 0.364 |
| | Absolute Value of Slope of Change | 0.0010 | 0.0008 | 0.0007 | 0.0006 | 0.0005 | 0.0004 |
| | in tan δ with Temperature (−) | | | | | | |
| | Rate of Change in Modulus of | 18 | 22 | 15 | 13 | 11 | 10 |
| | Repulsion Elasticity (%) | | | | | | |
| | Absolute Value of Difference in | 2 | 3 | 0 | 1 | 2 | 2 |
| | C Hardness (−) | | | | | | |
| | Absolute Value of Difference in | 0.027 | 0.029 | 0.024 | 0.023 | 0.019 | 0.022 |
| | Storage Modulus E′ (MPa) | | | | | | |

| | | Examples | | | | |
|---|---|---|---|---|---|---|
| | | 16 | 17 | 18 | 19 | 20 |
| Mixing | Natural Rubber (*1) | | | 40.00 | | 20.00 |
| | Synthetic Rubber A (*2) | | | | 40.00 | 20.00 |
| | Synthetic Rubber B (*3) | 100.00 | | 30.00 | 30.00 | 30.00 |
| | Synthetic Rubber C (*4) | | 100.00 | 30.00 | 30.00 | 30.00 |
| | Resin A (*5) | | | | | |
| | Resin A (*6) | | | | | |
| | Resin B (*7) | | | | | |
| | Resin C (*8) | | | | | |
| | Reinforcing Agent (*9) | | 12.00 | 12.00 | 12.00 | 12.00 |
| | Reinforcing Agent (*10) | | | | | |
| | Plasticizer (*11) | | | 20.00 | 20.00 | 20.00 |
| | Plasticizer (*12) | | | | | |
| | Plasticizer (*13) | | | | | |
| | Plasticizer (*14) | | | | | |
| | Plasticizer (*15) | | | | | |
| | Plasticizer (*16) | | | | | |
| | Plasticizer (*17) | | 40.00 | | | |
| | Silane Coupling Agent (*18) | | | | | |
| | Processing Aid (*19) | | | | | |
| | Crosslinking Aid A (*20) | 5.00 | 5.00 | 5.00 | 5.00 | 5.00 |
| | Crosslinking Agent A (*21) | 2.50 | 6.00 | 3.00 | 3.00 | 3.00 |
| | Crosslinking Agent B (*22) | | | | | |
| | Vulcanization Accelerator A (*23) | 0.50 | 0.60 | 0.50 | 0.50 | 0.50 |
| | Vulcanization Accelerator B (*24) | 0.20 | 0.20 | 0.20 | 0.20 | 0.20 |
| | Crosslinking Aid B (*25) | | | | | |
| | Foaming Agent (*26) | 3.00 | 3.00 | 3.00 | 3.00 | 3.00 |
| | Foaming Agent (*27) | | | | | |
| | Foaming Agent (*28) | 3.00 | 3.00 | 3.00 | 3.00 | 3.00 |
| | Total | 114.20 | 169.80 | 146.70 | 146.70 | 146.70 |
| Evaluation | Specific Gravity (g/cm³) | 0.24 | 0.26 | 0.20 | 0.23 | 0.21 |
| | C Hardness (Skin Off, −15° C.) (−) | 15 | 12 | 15 | 13 | 11 |
| | C Hardness (Skin Off, 24° C.) (−) | 14 | 13 | 16 | 14 | 11 |
| | Modulus of Repulsion Elasticity | 70 | 56 | 59 | 54 | 54 |
| | (Skin Off, −15° C.) (%) | | | | | |
| | Modulus of Repulsion Elasticity | 76 | 72 | 75 | 73 | 73 |
| | (Skin Off, 24° C.) (%) | | | | | |
| | tan δ (10 Hz, −15° C.) (−) | 0.049 | 0.115 | 0.097 | 0.114 | 0.097 |
| | tan δ (10 Hz, 24° C.) (−) | 0.030 | 0.056 | 0.047 | 0.054 | 0.046 |
| | Storage Modulus E′ (−15° C.) (MPa) | 0.416 | 0.302 | 0.279 | 0.326 | 0.287 |
| | Storage Modulus E′ (24° C.) (MPa) | 0.425 | 0.286 | 0.267 | 0.313 | 0.278 |
| | Absolute Value of Slope of Change | 0.0005 | 0.0015 | 0.0013 | 0.0015 | 0.0013 |
| | in tan δ with Temperature (−) | | | | | |
| | Rate of Change in Modulus of | 8 | 22 | 21 | 26 | 26 |
| | Repulsion Elasticity (%) | | | | | |
| | Absolute Value of Difference in | 1 | 1 | 1 | 1 | 0 |
| | C Hardness (−) | | | | | |
| | Absolute Value of Difference in | 0.010 | 0.016 | 0.012 | 0.013 | 0.009 |
| | Storage Modulus E′ (MPa) | | | | | |

TABLE 3

| | | Comparative Examples | | | | | | |
|---|---|---|---|---|---|---|---|---|
| | | 1 | 2 | 3 | 4 | 5 | 6 | 7 |
| Mixing | Natural Rubber (*1) | | | | | | | |
| Ratio | Synthetic Rubber A (*2) | 100.00 | 100.00 | 100.00 | 100.00 | 85.00 | | 80.00 |
| (Parts by | Synthetic Rubber B (*3) | | | | | | 100.00 | |
| Mass) | Synthetic Rubber C (*4) | | | | | | | 20.00 |
| | Resin A (*5) | | | | | 15.00 | | |
| | Resin A (*6) | | | | | | | |
| | Resin B (*7) | | | | | | | |
| | Resin C (*8) | | | | | | | |
| | Reinforcing Agent (*9) | 15.00 | 15.00 | 15.00 | | 15.00 | | 12.00 |
| | Reinforcing Agent (*10) | | | | | | 40.00 | |
| | Plasticizer (*11) | | | | | 20.00 | | 20.00 |
| | Plasticizer (*12) | | | | | | | |
| | Plasticizer (*13) | | | | | | | |
| | Plasticizer (*14) | 20.00 | | | | | 20.00 | |
| | Plasticizer (*15) | | 20.00 | | | | | |
| | Plasticizer (*16) | | | 20.00 | | | | |
| | Plasticizer (*17) | | | | | | | |
| | Silane Coupling Agent (*18) | | | | | | 4.00 | |
| | Processing Aid (*19) | | | | | | | |
| | Crosslinking Aid A (*20) | 5.00 | 5.00 | 5.00 | 5.00 | 5.00 | 5.00 | 5.00 |
| | Crosslinking Agent A (*21) | 3.00 | 3.00 | 3.00 | 3.00 | 3.00 | 1.00 | 3.00 |
| | Crosslinking Agent B (*22) | | | | | | | |
| | Vulcanization Accelerator A (*23) | 0.50 | 0.50 | 0.50 | 0.50 | 0.50 | 1.00 | 0.50 |
| | Vulcanization Accelerator B (*24) | 0.20 | 0.20 | 0.20 | 0.20 | 0.20 | 0.20 | 0.20 |
| | Crosslinking Aid B (*25) | | | | | | | |
| | Foaming Agent (*26) | 3.00 | 3.00 | 3.00 | 3.00 | 3.00 | 5.00 | 3.00 |
| | Foaming Agent (*27) | | | | | | | |
| | Foaming Aid (*28) | 3.00 | 3.00 | 3.00 | 3.00 | 3.00 | 5.00 | 3.00 |
| | Total | 149.70 | 149.70 | 149.70 | 114.70 | 149.70 | 181.20 | 146.70 |
| Evaluation | Specific Gravity (g/cm³) | 0.24 | 0.24 | 0.24 | 0.23 | 0.24 | 0.34 | 0.26 |
| | C Hardness (Skin Off, −15° C.) (−) | 14 | 13 | 13 | 23 | 22 | 14 | 15 |
| | C Hardness (Skin Off, 24° C.) (−) | 15 | 15 | 14 | 23 | 23 | 16 | 17 |
| | Modulus of Repulsion Elasticity | 39 | 40 | 38 | 43 | 44 | 48 | 45 |
| | (Skin Off, −15° C.) (%) | | | | | | | |
| | Modulus of Repulsion Elasticity | 76 | 74 | 76 | 77 | 75 | 54 | 76 |
| | (Skin Off, 24° C.) (%) | | | | | | | |
| | tan δ (10 Hz, − 15° C.) (−) | 0.137 | 0.133 | 0.136 | 0.137 | 0.150 | 0.138 | 0.130 |
| | tan δ (10 Hz, 24° C.) (−) | 0.027 | 0.019 | 0.018 | 0.021 | 0.021 | 0.160 | 0.033 |
| | Storage Modulus E′ (−15° C.) (MPa) | 0.395 | 0.214 | 0.267 | 0.567 | 0.602 | 0.759 | 0.257 |
| | Storage Modulus E′ (24° C.) (MPa) | 0.351 | 0.212 | 0.270 | 0.510 | 0.484 | 0.473 | 0.246 |
| | Absolute Value of Slope of Change | 0.0028 | 0.0029 | 0.0030 | 0.0030 | 0.0033 | 0.0006 | 0.0025 |
| | in tan δ with Temperature (−) | | | | | | | |
| | Rate of Change in Modulus of | 49 | 46 | 50 | 44 | 41 | 11 | 41 |
| | Repulsion Elasticity (%) | | | | | | | |
| | Absolute Value of Difference | 1 | 2 | 1 | 0 | 1 | 2 | 2 |
| | in C Hardness (−) | | | | | | | |
| | Absolute Value of Difference in | 0.044 | 0.002 | 0.003 | 0.057 | 0.118 | 0.286 | 0.011 |
| | Storage Modulus E′ (MPa) | | | | | | | |

| | | Comparative Examples | | | | | |
|---|---|---|---|---|---|---|---|
| | | 8 | 9 | 10 | 11 | 12 | 13 |
| Mixing | Natural Rubber (*1) | | | | | | |
| Ratio | Synthetic Rubber A (*2) | 60.00 | 40.00 | 20.00 | | | |
| (Parts by | Synthetic Rubber B (*3) | | | | | | |
| Mass) | Synthetic Rubber C (*4) | 40.00 | 60.00 | 80.00 | 100.00 | | |
| | Resin A (*5) | | | | | | |
| | Resin A (*6) | | | | | 80.00 | |
| | Resin B (*7) | | | | | | 80.00 |
| | Resin C (*8) | | | | | 20.00 | 20.00 |
| | Reinforcing Agent (*9) | 12.00 | 12.00 | 12.00 | 12.00 | | |
| | Reinforcing Agent (*10) | | | | | | |
| | Plasticizer (*11) | 20.00 | 20.00 | 20.00 | 20.00 | | |
| | Plasticizer (*12) | | | | | | |
| | Plasticizer (*13) | | | | | | |
| | Plasticizer (*14) | | | | | | |
| | Plasticizer (*15) | | | | | | |
| | Plasticizer (*16) | | | | | | |
| | Plasticizer (*17) | | | | | | |
| | Silane Coupling Agent (*18) | | | | | | |
| | Processing Aid (*19) | | | | | 0.60 | 0.60 |
| | Crosslinking Aid A (*20) | 5.00 | 5.00 | 5.00 | 5.00 | 1.80 | 1.80 |
| | Crosslinking Agent A (*21) | 3.00 | 3.00 | 3.00 | 3.00 | | |
| | Crosslinking Agent B (*22) | | | | | 0.70 | 0.70 |
| | Vulcanization Accelerator A (*23) | 0.50 | 0.50 | 0.50 | 0.50 | | |
| | Vulcanization Accelerator B (*24) | 0.20 | 0.20 | 0.20 | 0.20 | | |
| | Crosslinking Aid B (*25) | | | | | 0.10 | 0.10 |
| | Foaming Agent (*26) | 3.00 | 3.00 | 3.00 | 3.00 | | |
| | Foaming Agent (*27) | | | | | 3.00 | 2.60 |
| | Foaming Aid (*28) | 3.00 | 3.00 | 3.00 | 3.00 | | |
| | Total | 146.70 | 146.70 | 146.70 | 146.70 | 106.20 | 105.80 |
| Evaluation | Specific Gravity (g/cm³) | 0.24 | 0.25 | 0.25 | 0.25 | 0.20 | 0.20 |
| | C Hardness (Skin Off, −15° C.) (−) | 15 | 17 | 19 | 19 | 58 | 67 |
| | C Hardness (Skin Off, 24° C.) (−) | 17 | 18 | 20 | 20 | 47 | 53 |
| | Modulus of Repulsion Elasticity | 45 | 46 | 42 | 46 | 38 | 28 |
| | (Skin Off, −15° C.) (%) | | | | | | |
| | Modulus of Repulsion Elasticity | 77 | 73 | 69 | 65 | 64 | 65 |
| | (Skin Off, 24° C.) (%) | | | | | | |
| | tan δ (10 Hz, −15° C.) (−) | 0.157 | 0.167 | 0.180 | 0.202 | 0.169 | 0.236 |
| | tan δ (10 Hz, 24° C.) (−) | 0.055 | 0.065 | 0.082 | 0.121 | 0.083 | 0.070 |
| | Storage Modulus E′ (−15° C.) (MPa) | 0.451 | 0.433 | 0.557 | 0.589 | 9.664 | 12.000 |
| | Storage Modulus E′ (24° C.) (MPa) | 0.411 | 0.393 | 0.503 | 0.601 | 3.598 | 2.954 |
| | Absolute Value of Slope of Change | 0.0026 | 0.0026 | 0.0025 | 0.0021 | 0.0022 | 0.0043 |
| | in tan δ with Temperature (−) | | | | | | |
| | Rate of Change in Modulus of | 42 | 37 | 39 | 29 | 41 | 57 |
| | Repulsion Elasticity (%) | | | | | | |
| | Absolute Value of Difference | 2 | 1 | 1 | 1 | 11 | 14 |
| | in C Hardness (−) | | | | | | |
| | Absolute Value of Difference in | 0.040 | 0.040 | 0.054 | 0.012 | 6.066 | 9.046 |
| | Storage Modulus E′ (MPa) | | | | | | |

*1: SVR-CV60 (natural rubber)

*2: IR2200 (isoprene rubber, made by Zeon Corporation)

*3: BR230 (butadiene rubber, made by Ube Industries, Ltd.)

*4: JSR 1502 (styrene-butadiene rubber, made by JSR Corporation)

*5: RB820 (polybutadiene thermoplastic elastomer, made by JSR Corporation)

*6: DF810 (α-olefin copolymer, made by Mitsui Chemicals, Inc.)

*7: INFUSE9350 (olefin block copolymer, made by Dow Chemical)

*8: UE659 (ethylene vinyl acetate copolymer, made by USI Corporation)

*9: GOLDSTAR (magnesium carbonate, made by Konoshima Chemical Co., Ltd.)

*10: Nipsil ER (silica, made by Tosoh Silica Corporation)

*11: Chemical synthetic oil made by ExxonMobil (kinematic viscosity: 19 cst)

*12: Chemical synthetic oil made by ExxonMobil (kinematic viscosity: 5 cst)

*13: Liquid paraffin made by MORESCO Corporation (kinematic viscosity: 10 cst)

*14: Mineral oil made by Idemitsu Kosan Co., Ltd. (kinematic viscosity: 68 cst)

*15: Mineral oil made by Idemitsu Kosan Co., Ltd. (kinematic viscosity: 91 cst)

*16: Mineral oil made by Idemitsu Kosan Co., Ltd. (kinematic viscosity: 26 cst)

*17: Palm kernel fatty acid ester made by Lion Specialty Chemicals Co., Ltd. (kinematic viscosity: 5 cst)

*18: CABRUS4 (bis-(triethoxysilylpropyl)tetrasulfide, made by OSAKA SODA CO., LTD.)

*19: Stearic acid

*20: Zinc oxide (made by SEIDO CHEMICAL INDUSTRY CO., LTD.)

*21: Fine sulfur powder S, 200 mesh (made by Hosoi Chemical Industry Co., Ltd.)

*22: PERCUMYL D (dicumyl peroxide, made by NOF CORPORATION)

*23: NOCCELER CZ (N-cyclohexyl-2-benzothiazolyl sulfenamide, made by OUCHI SHINKO CHEMICAL INDUSTRIAL CO., LTD.)

*24: NOCCELER D (1,3-diphenylguanidine, made by OUCHI SHINKO CHEMICAL INDUSTRIAL CO., LTD.)

*25: TAC-70 (triallyl isocyanurate)

*26: CELLULAR D (N,N′-dinitrosopentamethylenetetramine, made by EIWA CHEMICAL IND. CO., LTD.)

*27: VINYFOR AC #3 (azodicarbonamide, made by EIWA CHEMICAL IND. CO., LTD.)

*28: CELL PASTE 101 (urea, made by EIWA CHEMICAL IND. CO., LTD.)

As shown in Tables 1 and 2, in Examples 1 to 20, the loss factor tan δ (24° C.) at a frequency of 10 Hz and 24° C. is 0.07 or less. Examples 1 to 20 therefore have high resilience at ordinary temperatures (resilience at 24° C. is 70 or higher).

Moreover, in Examples 1 to 20, the absolute value of the slope of the change in loss factor tan δ with temperature is 0.002 or less. Examples 1 to 20 therefore can maintain high resilience even at low temperatures (resilience at −15° C. is 50 or higher).

As described above, the present invention is particularly useful for rubber foams that are used for shoe soles.

What is claimed is:

1. A rubber foam for a shoe sole, the rubber foam being composed of a rubber composition for foaming containing a rubber composition and a foaming agent, wherein
a loss factor tan δ (24° C.) at a frequency of 10 Hz and 24° C. is 0.07 or less, and
an absolute value of a slope of a change in loss factor tan δ with temperature between a loss factor tan δ (−15° C.) at the frequency of 10 Hz and −15° C. and the loss factor tan δ (24° C.) at the frequency of 10 Hz and 24° C., as calculated by the following equation (1), is 0.002 or less:
[Math 1]
the absolute value of the slope of the change in tan δ with temperature=|[tan δ (−15° C.)−tan δ (24° C.)]/39 (1).

2. The rubber foam for a shoe sole according to claim 1, wherein
the loss factor tan δ (−15° C.) at the frequency of 10 Hz and −15° C. is 0.12 or less.

3. The rubber foam for a shoe sole according to claim 1, wherein
an absolute value of a difference between a storage modulus E′ (24° C.) at the frequency of 10 Hz and 24° C. and a storage modulus E′ (−15° C.) at the frequency of 10 Hz and −15° C. is 0.30 MPa or less.

4. The rubber foam for a shoe sole according to claim 1, wherein
the rubber composition is composed of at least one selected from the group consisting of natural rubber, isoprene rubber, butadiene rubber, and styrene-butadiene rubber.

5. The rubber foam for a shoe sole according to claim 1, further containing a resin component, wherein
a content of the resin composition based on a total of the rubber composition and the resin composition is 40 mass % or less.

6. The rubber foam for a shoe sole according to claim 1, further containing a plasticizer having a kinematic viscosity of 19 cst or less at 40° C., wherein
a content of the plasticizer based on the whole rubber composition is 20 mass % or more.

7. The rubber foam for a shoe sole according to claim 5, further containing a plasticizer having a kinematic viscosity of 19 cst or less at 40° C., wherein
a content of the plasticizer based on the total of the rubber composition and the resin composition is 20 mass % or more.

8. The rubber foam for a shoe sole according to claim 1, wherein
the rubber foam has a specific gravity of 0.6 or less.

9. The rubber foam for a shoe sole according to claim 1, wherein
the rubber foam is used for a midsole of a shoe. 27 R21-088 Atty. Ref.: MIZ265 116560345
